(19) United States
(12) Patent Application Publication
(10) Pub. No.: US 2005/0223181 A1
(43) Pub. Date: Oct. 6, 2005

(54) Integrated circuit capable of copy management

(76) Inventors: Roger C. Jeppsen, Chandler, AZ (US); Carl R. Delsey, Gilbert, AZ (US)

Correspondence Address: Grossman, Tucker, Perreault & Pfleger, PLLC;c/o PortfolioIP, P.O. Box 52050, Minneapolis, MN, 55402, US

(21) Appl. No.: 10/815,265

(22) Filed: Mar. 31, 2004

(51) Int. Cl. G06F 12/16

(52) U.S. Cl. 711/162

(57) ABSTRACT

A method according to one embodiment may include generating, by copy manager circuitry comprised in an integrated circuit, one or more copy commands to copy data from a first mass storage device to a second mass storage device via the integrated circuit. Of course, many alternatives, variations, and modifications are possible without departing from this embodiment.

### FIELD

The present disclosure relates to an integrated circuit capable of copy management.

### BACKGROUND

In one conventional data storage arrangement, a host system may include a host bus adapter (HBA). The HBA communicates with a data storage system via one or more communication links using a communication protocol associated with the one or more links. The host system manages backup operations to copy data from one storage device in the data storage system to another storage device in the data storage system. Conventional backup operations generated by a host system move data from one storage device, into the host system and back to another storage device. Thus, data must be moved over extended distances in the conventional data storage arrangement adding to communication link and data bus traffic. Further, in the conventional data storage arrangement, the host system is required to manage backup operations.

### BRIEF DESCRIPTION OF THE DRAWINGS

Features and advantages of embodiments of the claimed subject matter will become apparent as the following Detailed Description proceeds, and upon reference to the Drawings, wherein like numerals depict like parts, and in which:

FIG. 1 is a diagram illustrating a system embodiment;

FIG. 2 is a diagram illustrating another system embodiment; and

FIG. 3 is a flowchart illustrating exemplary operations according to one embodiment.

Although the following Detailed Description will proceed with reference being made to illustrative embodiments, many alternatives, modifications, and variations thereof will be apparent to those skilled in the art. Accordingly, it is intended that the claimed subject matter be viewed broadly, and be defined only as set forth in the accompanying claims.

### DETAILED DESCRIPTION

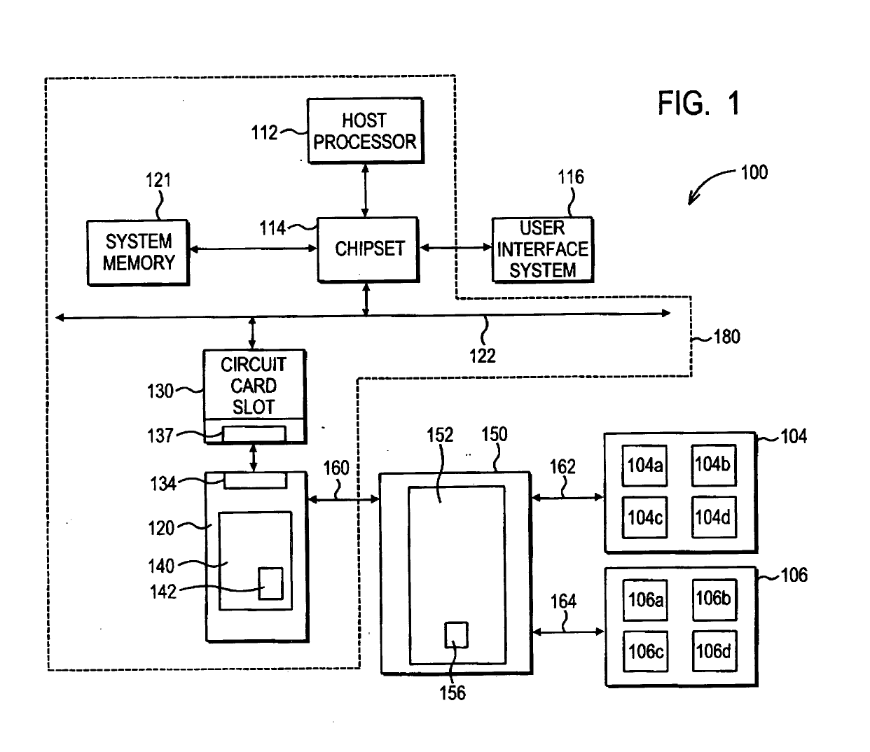

FIG. 1 illustrates a system embodiment 100 of the claimed subject matter. The system 100 may generally include a host processor 112, a bus 122, a user interface system 116, a chipset 114, system memory 121, a circuit card slot 130, and a circuit card 120 that is capable of communicating with the mass storage 104. The host processor 112 may include any variety of processors known in the art such as an Intel® Pentium® IV processor commercially available from the Assignee of the subject application. The bus 122 may include various bus types to transfer data and commands. For instance, the bus 122 may comply with the Peripheral Component Interconnect (PCI) Express™ Base Specification Revision 1.0, published Jul. 22, 2002, available from the PCI Special Interest Group, Portland, Oreg., U.S.A. (hereinafter referred to as a “PCI Express™ bus”). The bus 122 may also comply with the PCI-X Specification Rev. 1.0a, Jul. 24, 2000, available from the aforesaid PCI Special Interest Group, Portland, Oreg., U.S.A. (hereinafter referred to as a “PCI-X bus”).

The user interface 116 may include a variety of devices for human users to input commands and/or data and to monitor the system such as a keyboard, pointing device, and video display. The chipset 114 may include host bridge/hub system (not shown) that couples the processor 112, system memory 121, and user interface system 116 to each other and to the bus 122. Chipset 114 may include integrated circuit chips, such as those selected from integrated circuit chipsets commercially available from the assignee of the subject application (e.g., graphics memory and I/O controller hub chipsets), although other integrated circuit chips may also, or alternatively be used. The processor 112, system memory 121, chipset 114 and circuit card slot 130 may be integrated onto one motherboard.

The circuit card 120 may be constructed to permit it to be inserted into slot 130. When the circuit card 120 is properly inserted into slot 130, connectors 134 and 137 become electrically and mechanically coupled to each other. When connectors 134 and 137 are so coupled to each other, the card 120 becomes electrically coupled to bus 122 and may exchange data and/or commands with system memory 121, host processor 112, and/or user interface system 116 via bus 122 and chipset 114. Alternatively, without departing from this embodiment, the operative circuitry of the circuit card 120 may be included in other structures, systems, and/or devices. These other structures, systems, and/or devices may be, for example, in a motherboard, coupled to the bus 122. Processor 112, system memory 121, chipset 114, bus 122, and circuit card slot 130 may be comprised in a single circuit board. Alternatively, and without departing from this embodiment, circuit card 120 may comprise one or more chipsets comprised in a system motherboard. Processor 112, system memory 121, chipset 114, bus 122, circuit card slot 130 and circuit card 120 may be referred to herein as server 180. Server 180 may comprise a host system in a data storage arrangement.

The circuit card 120 may communicate with the mass storage 104 and/or 106 using a plurality of communication protocols. Circuit card 120 may comprise a host bus adaptor (HBA) which may be capable of exchanging commands and data between processor 112 and mass storage 104 and/or 106. The circuit card 120 may comprise one or more of a protocol initiator engine 140 that is adapted to initiate communication between the host system 132 and mass storage 104 and/or 106. The initiator engine 140 may comprise an integrated circuit 142 that may include circuitry that is capable of initiating communication between the host system 132 and mass storage 104 and/or 106. As used in any embodiment herein, “circuitry” may comprise, for example, singly or in any combination, hardwired circuitry, programmable circuitry, state machine circuitry, and/or firmware that stores instructions executed by programmable circuitry. “Integrated circuit”, as used in any embodiment herein, may mean a semiconductor device and/or microelectronic device, such as, for example, a semiconductor integrated circuit chip.

If a Fibre Channel (FC) protocol is used by circuit card 120 to exchange data and/or commands with mass storage 104 and/or 106, it may comply or be compatible with the interface/protocol described in “ANSI Standard Fibre Channel Physical and Signaling Interface-3 X3.303:1998 Specification.” Alternatively or additionally, if a serial ATA (S-ATA) protocol is used by controller circuit card 120 to exchange data and/or commands with mass storage 104 and/or 106, it may comply or be compatible with the protocol described in “Serial ATA: High Speed Serialized AT Attachment,” Revision 1.0a, published on Jan. 7, 2003 by the Serial ATA Working Group and/or earlier and/or later published versions of the SATA standard. Further alternatively or additionally, if a serial attached small computer system interface (SAS) protocol is used by controller circuit card 120 to exchange data and/or commands with mass storage 104 and/or 106, it may comply or be compatible with the protocol described in “Information Technology—Serial Attached SCSI—1.1,” Working Draft American National Standard of International Committee For Information Technology Standards (INCITS) T10 Technical Committee, Project T10/1562-D, Revision 1, published Sep. 18, 2003, by American National Standards Institute (hereinafter termed the “SAS Standard”) and/or earlier and/or later published versions of the SAS Standard. The SAS protocol may comprise Serial Advanced Attachment (ATA) Tunneled Protocol (STP) and Serial Small Computer System Interface (SCSI) Protocol (SSP).

Initiator engine 140 may comprise SAS initiator circuitry 142 capable of communicating with one or more drives comprised in mass storage 104 and/or mass storage 106 using SAS communication protocols. SAS initiator circuitry 142 may be capable of generating serial management protocol (SMP) commands, which may be defined by the aforementioned SAS standard, for exchanging commands and data with one or more drives comprised in mass storage 104 and/or 106.

In this embodiment, mass storage 104 may comprise one or more Serial SCSI disks 104a, 104b, 104c and/or 104d that comply or are compatible with SSP communication protocols (hereinafter “SAS drives” or “storage devices”). SAS drives may comprise one or more SAS hard disk devices. SAS devices may comprise one or more SAS tape storage devices. Mass storage 106 may comprise one or more Serial SCSI devices 106a, 106b, 106c and/or 106d that comply or are compatible with SSP communication protocols (hereinafter “SAS devices” or “storage devices”). SAS devices comprised in mass storage 106 may comprise one or more tape storage devices. In this embodiment, mass storage 104 may comprise, e.g., one or more redundant arrays of independent disks (RAID). The RAID level that may be implemented by RAID may be 0, 1, or greater than 1. RAID may comprise, for example, one or more disk mass storage devices and/or one or more peripheral devices (collectively or singly shown in FIG. 1 by the block referred to by numeral 104) comprised in a protocol domain. As used herein, a “protocol domain” means one or more apparatus that may communicate in accordance with a communication protocol. The protocol domain may comprise a SAS protocol domain. In this embodiment, mass storage 104 and/or mass storage 106 may each comprise, individually or collectively, a clustered network storage environment.

The present embodiment may also comprise an expander device 150 coupled to circuit card 120 via communications link 160. The expander device may also be coupled to mass storage 104 and/or 106, via communications links 162 and 164, respectively. As used in any embodiment herein, an “expander device” may comprise one or more integrated circuits which may comprise circuitry to transmit and/or receive at least one signal. Expander device 150 may be capable of coupling a plurality of devices together, such as devices comprised in mass storage 104 and/or 106, in a clustered environment. The expander device 150 may also be capable of expanding the number of target devices which may be coupled to circuit card 120, which may form a clustered network storage environment.

The expander device 150 may comprise an integrated circuit 152 and memory (not shown). Memory may comprise one or more of the following types of memories: semiconductor firmware memory, programmable memory, non-volatile memory, read only memory, electrically programmable memory, random access memory, flash memory, magnetic disk memory, and/or optical disk memory. Either additionally or alternatively, memory may comprise other and/or later-developed types of computer-readable memory. Machine-readable firmware program instructions may be stored in memory. As described below, these instructions may be accessed and executed by integrated circuit 152. Memory may be capable of storing copy instructions, to permit, for example, expander 150 to execute copy operations, as will be described more fully below. Expander device 150 may be capable of communication with one or more mass storage devices comprised in mass storage 104 and/or 106 using one or more of a plurality of communication protocols, such as the aforementioned SAS, SATA and/or FC communication protocols.

Initiator engine 140 and expander device 150 may be capable of exchanging SCSI commands. Such SCSI commands may comprise one or more commands as described in “Information Technology—SCSI Primary Commands—3 (SPC-3)” published on May 16, 2003 by the T10 Technical Committee of Accredited Standards Committee and/or later published versions. One such SCSI command may comprise an extended copy command. “Extended copy”, as used in any embodiment herein, may comprise one or more commands to transfer data between two or more storage devices.

In this embodiment, expander device 150 may be capable of performing copy operations to copy data between one or more drives comprised in mass storage 104 and/or one or more devices comprised in mass storage 106. Integrated circuit 152 comprised in expander device 150 may comprise a copy manager 156. A “copy manager”, as used in any embodiment herein, may comprise circuitry that performs data copy operations to copy data between one or more drives comprised in mass storage 104 and/or one or more devices comprised in mass storage 106. Also, “copy manager”, as used herein may generate one or more commands which may be defined in the aforementioned T10 standard. Copy manager 156 may comprise circuitry capable of generating one or more copy commands to copy data between one or more drives comprised in mass storage 104 and/or one or more devices comprised in mass storage 106 in response to an extended copy command.

An extended copy command may be generated by server 180 and transmitted to expander 150 via communication link 160. The extended copy command may cause the copy manager 156 comprised in expander device 150 to initiate communication with one or more disk drives comprised in mass storage 104 to copy data stored thereon to one or more tape devices comprised in mass storage 106. As an example, in operation, when expander device 150 is executing one or more data copy operations, data may be moved through expander device 150 from mass storage 104 to mass storage 106, via communication links 162 and 164. Thus, in this embodiment, it may not be necessary to move data through a server system (e.g., server 180) when executing a copy operation for data comprised in mass storage 104 and/or 106.

Also, in this embodiment, expander device 150 may be capable of determining that a copy operation between mass storage 104 and 106 is complete, and may be further capable of generating a signal to server 180 indicating a complete copy operation. Alternatively or additionally, expander device 150 may be capable of discovering one or more errors that may occur during copy operations between mass storage 104 and mass storage 106, and may further be capable of reporting such errors to server 180.

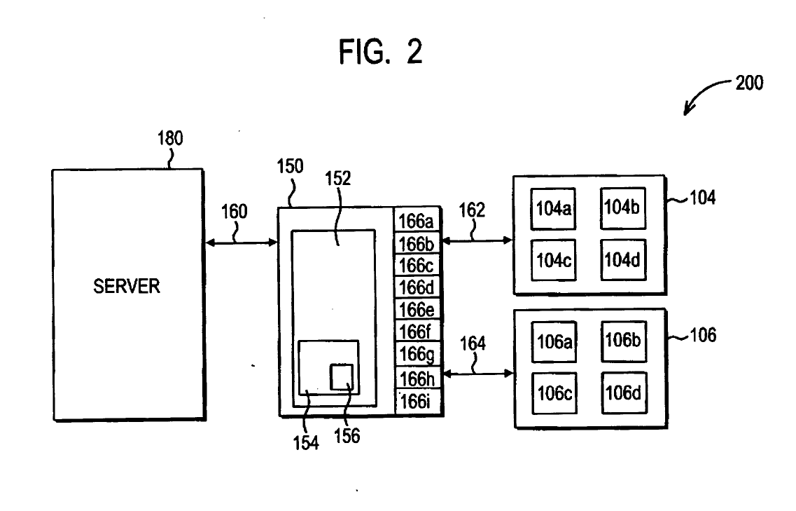

FIG. 2 illustrates another system embodiment 200 of the claimed subject matter. In FIG. 2, certain portions of the system 100 depicted in FIG. 1 have been omitted for clarity (for example circuit board 132 and circuit card 120), but it is to be understood that like parts of FIG. 2 can be implemented in a manner consistent with an embodiment depicted in FIG. 1, or alternatively in other system implementations, without departing from this embodiment.

Expander device 150 may also comprise one or more physical interfaces (PHY) 166a, 166b, 166c, 166d, 166e, 166f, and/or 166g capable of electrically coupling expander device 150 with one or more SAS and/or SATA drives comprise in mass storage 104 and/or 106. A “PHY” may be defined as an object and/or circuitry used to interface to one or more devices, and such object and/or circuitry may be defined by one or more of the communication protocols set forth herein. The PHY may comprise a physical PHY containing transceiver circuitry to interface to a communication link. The PHY may alternately and/or additionally comprise a virtual PHY to interface to another virtual PHY or to a physical PHY. Each PHY may have a unique identifier. The expander device 150 may also comprise one or more ports (not shown). A port may contain one or more PHYs. For example, a narrow port may contain only one PHY, while a wide port may contain more than one PHY. In this embodiment, one or more SAS drives (e.g. storage devices comprised in mass storage 104) may be coupled to a plurality of PHYs comprised in expander 150, for example PHYs 166a, 166b, 166c, and 166d. Also, in this embodiment, of FIG. 1, one ore more SAS devices (e.g., storage device comprised in mass storage 106) may be coupled to a plurality of PHYs comprised in expander 150, for example 166f, 166g, 166h and 166i. Thus, although FIG. 2 depicts communication link 162 which may couple mass storage 104 to expander 150 and communication link 164 which may couple mass storage 106 to expander 160, it should be understood that a plurality of communication links may be provided in this embodiment, for example, one link provided between each PHY and each drive comprised in mass storage 104 and 106. Circuitry 152 may be capable of controlling one or more PHYs comprised in expander 150, for example, to communicate with mass storage devices comprised in mass storage 104 and/or 106.

In this embodiment, integrated circuit 152 may comprise a virtual end device 154. “Virtual end device” may mean a device that may be simulated by the expander 150 and that is capable of appearing as a physical device. A virtual end device may be defined by the aforementioned SAS standard. In this embodiment, the virtual end device 154 may comprise a copy manager 156.

Server 180 may be capable of determining the number of devices present in mass storage 104, mass storage 106. Server 180 may also be capable of discovering a copy manager target, such as copy manager 156 defined in expander 150 as a virtual end device. Server 180 may comprise a backup application which may be operable to generate commands to initiate a backup operation for data on one or more drives comprised in mass storage 104 and/or 106. As used herein, “backup application” may comprise machine-executable instructions that may cause a machine to generate commands to copy data from one location to another. In the case of server 180, such machine-executable instructions may be executed by host processor 112 (as depicted in FIG. 1). In this embodiment, server 180, when executing a backup application, may be capable of discovering a copy manager comprised in expander 150. Also in this embodiment, when server 180 executes a backup application, server 180 may be capable of generating one or more extended copy commands to the copy manager 154 to perform data backup operations.

In operation, when the copy manager 156 receives one or more extended copy commands from the server 180, copy manager 156 may initiate copy commands. As an example, a backup application may specify instructions to copy data from one or more disk drives comprised in mass storage 104 to one or more tape devices comprised in mass storage 106. Copy commands may cause integrated circuit 152 to instruct one or more disks comprised in mass storage 104 to copy data to one or more tapes comprised in mass storage 106. In this embodiment, data may be transmitted between mass storage 104 and mass storage 106 via communication links 162 and 164, and via expander 150.

Expander device 150 may be capable of determining the presence and/or availability of one or more devices comprised in mass storage 104 and/or 106. Expander device 150 may also be capable of discovering SAS address information for one or more devices comprised in mass storage 104 and/or 106, and may be capable of reporting SAS address information to server 180. Server 180 may be capable of determining which devices to utilize for backup operations, as may be defined in the backup application, based at least in part on SAS address information provided by the expander 150. Also, in this embodiment, expander device 150 may be capable of determining that a copy operation between mass storage 104 and 106 is complete, and may be further capable of generating a signal to server 180 indicating a complete copy operation. Alternatively or additionally, expander device 150 may be capable of discovering one or more errors that may occur during copy operations between mass storage 104 and mass storage 106, and may further be capable of reporting such errors to server 180.

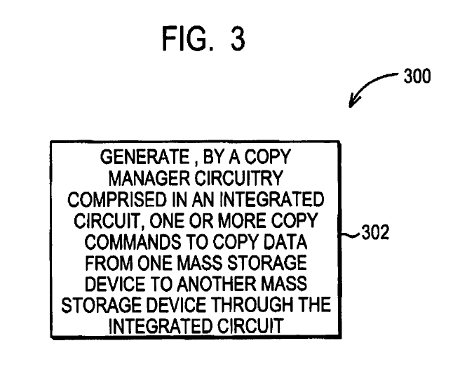

FIG. 3 depicts a flowchart 300 of operations which may be performed according to an embodiment. Operations may include generating, by copy manager circuitry comprised in an integrated circuit, copy commands to copy data from one mass storage device to another mass storage device via the integrated circuit 302.

Thus, at least one embodiment described herein may provide an integrated circuit that may be capable of executing copy commands between mass storage devices without requiring data transfer through a host server system. In at least one embodiment, the integrated circuit may comprise a copy manager circuitry capable of generating copy commands to copy data between mass storage devices. The copy manager may comply or be compatible with SCSI standard commands and requests, and may further be capable of receiving an extended copy command to initiate copy commands to copy data between mass storage devices. Thus, the integrated circuit according to at least one embodiment herein may be capable of data transfers between mass storage devices without burdening the host server system and/or communication links between the server system and the integrated circuit to achieve data backup and/or copy management operations.

Thus, in summary, at least one embodiment herein may provide an integrated circuit capable of communicating with at least a first storage device and a second storage device. The integrated circuit may comprise copy manager circuitry. The copy manager circuitry may be capable of generating one or more copy commands to copy data from the first storage device to the second storage device via the integrated circuit.

In the embodiments described herein, storage devices comprised in mass storage 104 and 106 may comply or may be compatible with SAS communication protocols. Alternatively or additionally, one or more storage devices comprised in mass storage 104 and/or 106 may comply or may be compatible with SATA communication protocols, and/or other communication protocols. To that end, expander device 150 may comprise SAS to SATA translator circuitry (not shown), to permit, for example SATA devices to be enumerated by a backup application, as may be comprised in server 180. In this case, expander device 150 and copy manager 154 may be capable of transferring data between one or more SATA devices comprised in mass storage 104 and/or 106, or between one or more SATA devices comprised in mass storage 104 and/or 106 and one or more SAS storage devices comprised in mass storage 104 and/or 106.

Further, in other embodiments, it is contemplated herein that copy manager circuitry 156, as may be defined herein, may be comprised in one or more integrated circuits other than an integrated circuit 152 comprised in expander device 150, and such a copy manager may be capable of performing operations described herein with reference to copy manager circuitry 156. For example, it is equally contemplated herein that copy manager circuitry may be comprised in integrated circuit 140 comprised in circuit card 120, and that circuit card 120 may be capable of performing operations described herein with reference to integrated circuit 152 and copy manager circuitry 156. As another example, it is equally contemplated herein that copy manager circuitry may be comprised in an integrated circuit comprised in server 180, and that server 180 may be capable of performing operations described herein with reference to copy manager circuitry. Other devices, circuitry, machines and/or integrated circuits not depicted in FIGS. 1 and 2 may also comprise copy manager circuitry, and that such other devices, circuitry, machines and/or integrated circuits may be capable of performing operations described herein with reference to copy manager circuitry.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Other modifications, variations, and alternatives are also possible. Accordingly, the claims are intended to cover all such equivalents.

1. An apparatus, comprising:
an integrated circuit capable of communicating with at least a first storage device and a second storage device, said integrated circuit comprising copy manager circuitry, said copy manager circuitry capable of generating one or more copy commands to copy data from said first storage device to said second storage device via said expander device.

2. The apparatus of claim 1, wherein:
said integrated circuit capable of receiving an extended copy command, and in response to said extended copy command, said copy manager circuitry generating one or more copy commands to copy data from said first storage device to said second storage device via said integrated circuit.

3. The apparatus of claim 1, wherein:
said integrated circuit comprising a virtual end device, said copy manager comprised in said virtual end device.

4. The apparatus of claim 1, wherein:
said first storage device comprises a disk device, and said second storage device comprises a tape device.

5. The apparatus of claim 1, wherein:
said integrated circuit comprised in an expander device, said expander device being coupled to said first storage device and said second storage device.

6. A method, comprising:
generating, by copy manager circuitry comprised in an integrated circuit, one or more copy commands to copy data from a first mass storage device to a second mass storage device via said integrated circuit.

7. The method of claim 6, further comprising:
receiving an extended copy command, and in response to said extended copy command, generating, by said copy manager circuitry, one or more copy commands to copy data from one said first mass storage device to said second mass storage device via said expander device.

8. The method of claim 6, further comprising:
defining said copy manager circuitry in a virtual end device.

9. The method of claim 6, wherein:
said first mass storage device comprises a disk device, said second mass storage device comprises a tape device.

10. The method of claim 6, wherein:
said integrated circuit comprised in an expander device, said expander device being coupled to said first storage device and said second storage device.

11. A system, comprising:
a circuit card comprising an integrated circuit capable of communicating in accordance with a plurality of different communication protocols, the circuit card being capable of being coupled to a bus, and an expander device capable of communicating with said circuit card and with at least a first storage device and a second storage device, said expander device comprising copy manager circuitry, said copy manager circuitry capable of generating one or more copy commands to copy data from said first storage device to said second storage device via said expander device.

12. The system of claim 11, wherein:
said expander device capable of receiving an extended copy command, and in response to said extended copy command, said copy manager circuitry generating one or more copy commands to copy data from said first storage device to said second storage device via said expander device.

13. The system of claim 12, wherein:
said extended copy command being transmitted by said circuit card to said expander device.

14. The system of claim 11, wherein:
said expander device comprising a virtual end device, said copy manager comprised in said virtual end device.

15. The system of claim 11, wherein:
said first storage device comprises a disk device, and said second storage device comprises a tape device.

16. An article comprising:
a storage medium having stored thereon instructions that when executed by a machine result in the following operations:
generating, by copy manager circuitry comprised in an integrated circuit, one or more copy commands to copy data from a first mass storage device to a second mass storage device via said integrated circuit.

17. The article of claim 16, further comprising the following operations:
receiving an extended copy command, and in response to said extended copy command, generating, by said copy manager circuitry, one or more copy commands to copy data from one said first mass storage device to said second mass storage device via said integrated circuit.

18. The article of claim 16, further comprising the following operations:
defining said copy manager circuitry in a virtual end device comprised in said integrated circuit.

19. The article of claim 16, wherein:
said first storage device comprises a disk device, and said second storage device comprises a tape device.
